(19) United States
(12) Patent Application Publication
(10) Pub. No.: US 2017/0198552 A1
(43) Pub. Date: Jul. 13, 2017

(54) SUBSEA CHEMICAL MANAGEMENT

(71) Applicant: GE Oil & Gas UK Limited, Bristol (GB)

(72) Inventors: Charles Anthony AUGUST, Bristol (GB); Robert DALZIEL, Bristol (GB)

(73) Assignee: GE Oil & Gas UK Limited, Bristol (GB)

(21) Appl. No.: 15/314,673

(22) PCT Filed: May 26, 2015
(86) PCT No.: PCT/EP2015/061533

§ 371 Date: Nov. 29, 2016

(30) Foreign Application Priority Data
May 29, 2014 (GB) 1409551.7

(51) Int. Cl. E21B 41/00; B01D 17/02; B01D 3/00; E21B 17/00

(52) U.S. Cl. CPC E21B 41/0007; E21B 17/00; B01D 17/0208; B01D 17/0217; B01D 3/00

(57) ABSTRACT

A method of supplying chemicals to an underwater location via a supply line (1), the method comprising the steps of: at a first end (13) of the supply line, supplying a chemical mixture comprising at least two non-identical chemicals; and at a second end (3) of the supply line, separating the chemical mixture into its constituent chemicals, wherein the first end of the supply line is located at a surface location and the second end of the supply line is located at an underwater location.

### BACKGROUND

Embodiments of the present invention relate to apparatus and method for supplying chemicals to an underwater location. In particular, embodiments relate to an apparatus and method for supplying a chemical mixture down a supply line which runs from a surface location to an underwater location, the chemical mixture being separated into its constituent chemicals at the underwater location. In an embodiment, the underwater location is a hydrocarbon extraction facility.

The oil and gas industry is increasingly moving towards all-electric arrangements for underwater hydrocarbon extraction facilities (for subsea controls, for example trees and actuators), allowing for an umbilical of reduced cost due to the elimination of, for example, hydraulic lines in the umbilical. A component that cannot be easily removed from the umbilical is a chemical supply line, as these are often needed throughout the life of the facility and chemicals must be supplied consistently, with one dedicated chemical supply line required for each of various chemicals.

It is an aim of the present invention to reduce the number of chemical supply lines required. This aim is achieved by using a single chemical line to send multiple chemicals, in particular in liquid form, to the underwater area in which they are needed, for example the wellhead of the hydrocarbon extraction facility.

As prior art, there may be mentioned UK Patent Application No. 1322379.7, which discloses a method of sending multiple chemicals down a single line in discrete slugs.

### BRIEF DESCRIPTION

Embodiments of the present invention are intended for future oil and gas fields where there are few, or no, hydraulic lines from the surface, with the aim of providing only electrical power and communications are sent from the surface to subsea. However, even if hydraulic lines are eliminated entirely, chemicals will still be needed to be provided from the surface to subsea for the production fluid. Embodiments of the present invention reduce the need for intervention vessels to fill up large subsea storage tanks if the number of chemical supply lines is reduced.

Embodiments of the present invention enable a reduction in the number of chemical supply lines by supplying multiple chemicals down a common supply line.

Embodiments of the present invention take a single flow with mixed chemicals arriving subsea, and manages it to various locations (such as storage, an injection point, or a return/waste system) after separating the chemical mixture. This is achieved by monitoring the flow of the chemical mixture in the supply line with a set of sensors, and the subsequent separation of the chemical mixture. As the chemical mixture arrives at the seabed, the system confirms the composition of the chemical mixture in the supply line and then sends it to a separation tank. The separation tank separates the chemical mixture into its constituent chemicals, which flow to various chemical stores ready for use, or straight to use in a subsea production system.

In this specification, the term “chemical mixture” is intended to encompass any combination of two or more chemicals, wherein the two or more chemicals do not chemically react with one another (for example, to form a precipitate). This includes colloidal systems, emulsions or suspensions of two or more chemicals, and solutions where one or more solute is dissolved in a solvent. The term “chemical mixture” is intended to encompass chemical combinations of any phase, e.g. single phase, dispersed phase, multi-phase, etc.

Embodiments of the present invention reduce the cost of a field through a reduced number of chemical lines to the field (compared to the case of smaller, but dedicated chemical lines being included in a field design), reduced material requirements and reduced installation costs. It also removes the need for excessive storage.

In accordance with a first aspect of the present invention there is provided a method of supplying chemicals to an underwater location via a supply line, the method comprising the steps of: at a first end of the supply line, supplying a chemical mixture comprising at least two non-identical chemicals; and at a second end of the supply line, separating the chemical mixture into its constituent chemicals, wherein the first end of the supply line is located at a surface location and the second end of the supply line is located at the underwater location.

The method may further comprise the step of storing each constituent chemical in a respective chemical store at the underwater location.

The method may further comprise the step of sensing the composition of the chemical mixture prior to the step of separating the chemical mixture into its constituent chemicals. In this case, the method may further comprise the step of analysing the sensed composition. The chemical mixture may be discarded if the analysis reveals that the at least two non-identical chemicals have chemically reacted.

The step of separating the chemical mixture into its constituent chemicals may comprise separating the chemical mixture using gravity separation in at least one separation tank. The step of separating the chemical mixture using gravity separation may comprise using at least two separation tanks connected in series, in parallel, or a combination of the two.

The step of separating the chemical mixture into its constituent chemicals may comprise separating the chemical mixture using a centrifuge.

The step of separating the chemical mixture into its constituent chemicals may comprise separating the chemical mixture using distillation.

The step of separating the chemical mixture into its constituent chemicals may comprise separating the chemical mixture using filtration.

The step of sensing the chemical mixture may comprise sensing one of: electrical capacitance, electrical inductance, resistivity, gamma densitometer, ultrasound, computed tomography (CT), pH measurements, optical measurements, radiological measurements, and fluorescence measurements.

The second end of the supply line may be located at an underwater hydrocarbon extraction facility.

The chemical mixture may be substantially homogeneous.

The method may further comprise a preliminary step of mixing the at least two non-identical chemicals to form the chemical mixture.

In accordance with a second aspect of the present invention there is provided an apparatus for supplying chemicals to an underwater location, comprising: a supply line; at a first end of the supply line, a supply means for supplying a chemical mixture comprising at least two non-identical chemicals to the supply line; and at a second end of the supply line, a separation means for separating the chemical mixture into its constituent chemicals, wherein the first end of the supply line is located at a surface location and the second end of the supply line is located at the underwater location.

The apparatus may further comprise respective chemical stores for each constituent chemical at the underwater location.

The apparatus may further comprise at least one sensor capable of sensing the composition of the chemical mixture at the second end of the supply line. The apparatus may further comprise means for analysing the sensed composition. The apparatus may comprise means for discarding the chemical mixture if the analysis reveals that the at least two non-identical chemicals have chemically reacted.

The separation means may comprise at least one separation tank.

The separation means may comprise at least two separation tanks connected in series, in parallel, or a combination of the two.

The separation means may comprise a centrifuge.

The separation means may comprise a still.

The separation means may comprise a filter.

The at least one sensor may be sensitive to at least one of: electrical capacitance, electrical inductance, resistivity, gamma densitometer, ultrasound, computed tomography (CT), pH measurements, optical measurements, radiological measurements, and fluorescence measurements.

The second end of the supply line may be located at an underwater hydrocarbon extraction facility.

The chemical mixture may be substantially homogeneous.

The apparatus may further comprise a mixing means for mixing the at least two non-identical chemicals to form the chemical mixture.

### BRIEF DESCRIPTION OF THE DRAWINGS

Embodiments of the invention will now be described with reference to the accompanying drawings, in which:

FIG. 1 schematically shows a schematic illustration of a method of supplying chemicals to an underwater location via a supply line according to a first embodiment of the present invention.

### DETAILED DESCRIPTION

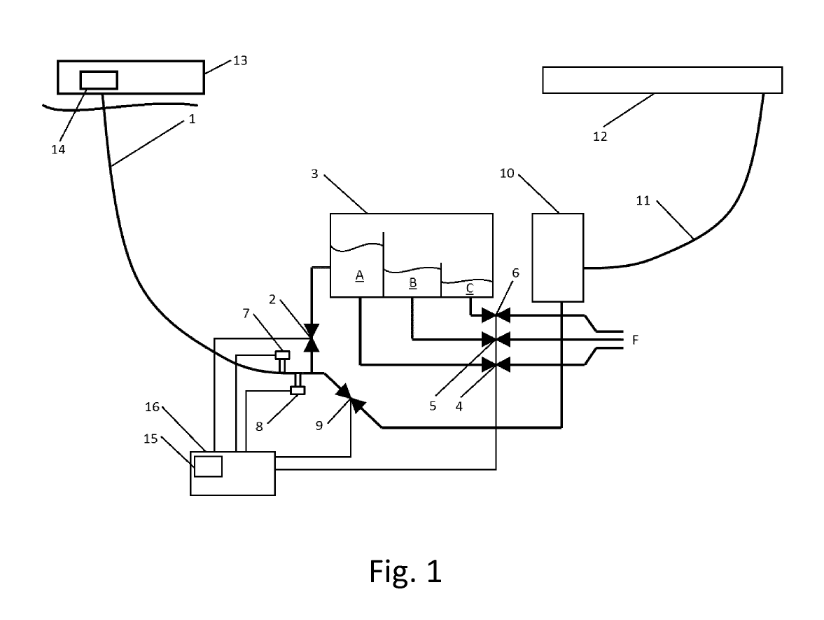

FIG. 1 shows a schematic illustration of a method of supplying chemicals via a supply line according to a first embodiment of the invention. An embodiment of the invention is implemented by sending a chemical mixture down a single supply line 1. Two or more chemicals are deliberately mixed at a first end of the supply line 1 (i.e. at a surface, or ‘topside’, location 13) before being sent down the supply line 1 as a chemical mixture. Deliberate mixing ensures that a substantially homogeneous mixture is formed, having a known amount of each chemical per unit volume. This can be beneficial, as a homogeneous chemical mixture will travel along the supply line at a substantially consistent rate, allowing the arrival time at a second end of the supply line 1 to be calculated. A mixing means 14 is illustrated at the surface location 13. This may be an active mixing system, such as a tank with a mixing paddle, or a passive mixing system, such as vanes provided in a tube through which the chemicals flow to cause the chemicals to become mixed through induced turbulent flow, or a combination of active and passive mixing systems.

Alternatively, two or more chemicals can be separately provided to the first end of the supply line 1, and the chemicals can mix in the supply line 1. To this end, vanes may be provided in the supply line 1 to facilitate mixing.

Once the chemical mixture arrives at the second end of the supply line 1 (i.e. at an underwater location, such as the sea bed) the chemical mixture passes through a control valve 2 into a separation means. In this example, the separation means is a separator tank 3, which uses gravity separation to separate the chemical mixture into its constituent chemicals, shown as A, B and C.

Although only one separator tank 3 is shown in FIG. 1, multiple separator tanks may be used in practice. The tanks may be connected in series or parallel as appropriate to give the optimal separation of the specific chemical mixture to be separated. Other separation means may also be used, either to replace the separation tank 3, or to supplement it. Such other separation means may include, for example, centrifuges, stills for distillation, or filters.

One the chemical mixture has been separated into its constituent chemicals, each chemical may be routed from separation means for use, or storage for future use. In the example of FIG. 1, the apparatus includes three control valves 4, 5, and 6 for routing the respective chemicals A, B and C for use an underwater facility F (such as, for example, an underwater hydrocarbon extraction facility). However, the chemicals could also be routed to respective storage tanks for future use. The fluids may be delivered to one or more point of delivery in the subsea environment, such as, for example, Christmas trees, manifolds, and subsea factory components such as pumps and separators.

A pair of sensors 7, 8 is located at the second end of the supply line 1, upstream of the separation tank 3, to sense the arriving chemical mixture and ensure its integrity. Two sensors are used in this embodiment to provide redundancy in case of the failure of one of the sensors. Chemical determination may also be improved by using a combination of two dissimilar sensing techniques, i.e. using sensors 7 and 8 in combination. However, only one sensor need be used in practice.

The sensors 7, 8 can sense (through, for example, sensing of the chemical mixture's density, electrical conductance, etc.) the composition of the chemical mixture, and may also include means to analyse the composition of the chemical mixture. Processing means may be used to combine the outputs of each sensor to provide enhanced identification. In this embodiment, the processing means comprises a subsea electronics module (SEM) 15 located within a subsea control module (SCM) 16. The SEM 15 also contains control circuitry for the SCM 16, which operates control valves within the underwater facility F. As illustrated, in this embodiment the SCM 16 also operates the control valves 2, 4, 5, 6 and 9.

If a ‘clean’ (i.e. not reacted) chemical mixture is established, the chemical mixture is routed, via the control valve 2, to the separator tank 3. Incorrect or reacted chemical mixtures are sent, via a control valve 9, to a waste tank 10. Waste chemicals in the waste tank 10 are purged via a waste line 11 into a riser 12. Alternatively, waste chemicals may be returned by a separate line next to the riser 12, or simply purged into sea.

Although three chemicals are discussed in the example above, it will be apparent that the method will also work with only two chemicals, and that there is no upper limit on how many different chemicals could be provided using the method and apparatus according to embodiments of the present invention. In practice, the number of different chemicals in the mixture will depend on the specific application at hand.

Suitable materials for the inner wall of the supply line include PTFE or other non-reactive plastic material, a hydrophobic material, stainless metals such as stainless steel, or ceramics. A hydrophobic-type chemical could also be applied to the inner wall of the supply line to help prevent pipe contamination. If an inert separator is used between sections of chemical mixture, said inert separator could be designed to clean the inner wall of the supply line as it moves through the supply line.

Common, bulk fluids used in underwater facilities include ethylene glycol (MEG) and methanol (MeOH).

Fluids required in smaller volumes include scale inhibiters, hydrate inhibitors, etc.

Injection rates may vary between low flow and high flow dependent on chemical demand. Low flow is usually considered as the range of about 0.3 litres per hour to about 100 litres per hour, with high flow usually being about 100 to about 9000 litres per hour, with pressures usually from about 5 kPsi (34.47 MPa) to about 15 kPsi (103.42 MPa).

If inert separators are used between sections of chemical mixture these could be solid plugs, or inert fluids/gels, or ice. As a solid plug, pipe inspection gauges (PIGs) could be used. These would need to be collected from the seabed, or could be left on the sea floor if made from a biodegradable material. The inert separator could be designed to clean or inspect the inner wall of the supply line as it moves through the supply line.

The sensing system could use any of the following sensors that are already deployed subsea, such as:

i. electrical capacitance/inductance

ii. resistivity

iii. gamma densitometer

iv. ultrasound

v. computed tomography (CT)

vi. pH measurements

vii. optical measurements

viii. radiological measurements

ix. fluorescence measurements.

A combination of dissimilar sensing technologies could deliver a more effective determination of the chemical mixture. Any sensors may be provided with associated processing means for using the data produced by the sensor for identification.

The chemical stores could store chemicals individually via respective fixed volume storage vessels (with or without pressure compensation), or individually via flexible volume storage vessels, such as, for example, inflatable storage devices, or expanding rigid devices.

When the chemicals are required for use at some point in the underwater facility, the chemicals may be delivered using in-built pressure from the storage vessel pressure compensation, or they may be delivered using pressure from another part of the system, such as from a work-over system, a local hydraulic system or a local pressure storage system. The chemicals may also be pumped to their required destination.

The return system should ensure that any mixed chemical sections that are ‘rejected’ by the sensing system, and any detected inert sections, are separated to bypass the operational components of the underwater facility. If PIGs are used, a collection method, a pigging loop, or pig launcher to collect the pigs should be provided.

Waste fluids could be discharged into the production line (assuming volumes are not significant). Waste could be temporarily held in a waste storage tank (as standard or in the event of sensor failure) and purged into the production line as, and when, required. Any fluids used to clean or flush the supply line should be directed to the production line or held in the waste storage tank for subsequent disposal.

The invention is not limited to the specific embodiments disclosed above, and other possibilities will be apparent to those skilled in the art.

For example, two or more supply lines could be used to give the system redundancy. Although this would increase the cost of the system, it would likely still be cheaper than prior art systems with one line per chemical (often resulting in five or more lines).

An arrangement is possible where the sensors are omitted entirely and replaced with a control system using simple flow meters. As it will be known what order and volume chemical mixtures have been injected into the first end of the supply line at the surface location, a control system at the second end may receive data from the first end to operate the valves and direct chemicals to the separation means based simply on how much fluid has passed the flow meters. This could also be done based on the time elapsed from chemical injection at the first end.

It is to be understood that even though numerous characteristics and advantages of various embodiments have been set forth in the foregoing description, together with details of the structure and functions of various embodiments, this disclosure is illustrative only, and changes may be made in detail, especially in matters of structure and arrangement of parts within the principles of the embodiments to the full extent indicated by the broad general meaning of the terms in which the appended claims are expressed. It will be appreciated by those skilled in the art that the teachings disclosed herein can be applied to other systems without departing from the scope and spirit of the application.

What is claimed is:

1. A method of supplying chemicals to an underwater location via a supply line, the method comprising:
at a first end of the supply line, supplying a chemical mixture comprising at least two non-identical chemicals; and
at a second end of the supply line, separating the chemical mixture into its constituent chemicals,
wherein the first end of the supply line is located at a surface location and the second end of the supply line is located at an underwater location.

2. The method according to claim 1, further comprising
storing each constituent chemical in a respective chemical store at the underwater location.

3. The method according to claim 1, the method further comprising sensing the composition of the chemical mixture prior to separating the chemical mixture into its constituent chemicals.

4. The method according to claim 3, further comprising analysing the sensed composition.

5. The method according to claim 4, further comprising discarding the chemical mixture if the analysis reveals that the at least two non-identical chemicals have chemically reacted.

6. The method according to claim 1, wherein separating the chemical mixture into its constituent chemicals comprises separating the chemical mixture using gravity separation in at least one separation tank.

7. The method according to claim 6, wherein separating the chemical mixture using gravity separation comprises using at least two separation tanks connected in series.

8. The method according to claim 6, wherein separating the chemical mixture using gravity separation comprises using at least two separation tanks connected in parallel.

9. The method according to claim 1, wherein separating the chemical mixture into its constituent chemicals comprises separating the chemical mixture using a centrifuge.

10. The method according to claim 1, wherein separating the chemical mixture into its constituent chemicals comprises separating the chemical mixture using distillation.

11. The method according to claim 1, wherein separating the chemical mixture into its constituent chemicals comprises separating the chemical mixture using filtration.

12. The method according to claim 3, wherein sensing the chemical mixture comprises sensing one of: electrical capacitance, electrical inductance, resistivity, gamma densitometer, ultrasound, computed tomography (CT), pH measurements, optical measurements, radiological measurements, and fluorescence measurements.

13. The method according to claim 1, wherein the second end of the supply line is located at an underwater hydrocarbon extraction facility.

14. The method according to claim 1, wherein the chemical mixture is substantially homogeneous.

15. The method according to claim 1, further comprising a preliminary step of mixing the at least two non-identical chemicals to form the chemical mixture.

16. An apparatus for supplying chemicals to an underwater location, the apparatus comprising:
a supply line;
at a first end of the supply line, a supply means for supplying a chemical mixture comprising at least two non-identical chemicals to the supply line; and
at a second end of the supply line, a separation means for separating the chemical mixture into its constituent chemicals,
wherein the first end of the supply line is located at a surface location and the second end of the supply line is located at an underwater location.

17. The apparatus according to claim 16, further comprising:
respective chemical stores for each constituent chemical at the underwater location.

18. The apparatus according to claim 16, further comprising at least one sensor configured to sense the composition of the chemical mixture at the second end of the supply line.

19. The apparatus according to claim 18, further comprising means for analysing the sensed composition.

20. An apparatus according to claim 19, wherein the apparatus comprises means for discarding the chemical mixture if the analysis reveals that the at least two non-identical chemicals have chemically reacted.

21. The apparatus according to claim 16, wherein the separation means comprises at least one separation tank.

22. The apparatus according to claim 21, wherein the separation means comprises at least two separation tanks connected in series.

23. The apparatus according to claim 21, wherein the separation means comprises at least two separation tanks connected in parallel.

24. The apparatus according to claim 16, wherein the separation means comprises a centrifuge.

25. The apparatus according to claim 16, wherein the separation means comprises a still.

26. The apparatus according to claim 16, wherein the separation means comprises a filter.

27. The apparatus according to claim 18, wherein the at least one sensor is sensitive to at least one of: electrical capacitance, electrical inductance, resistivity, gamma densitometer, ultrasound, computed tomography (CT), pH measurements, optical measurements, radiological measurements, and fluorescence measurements.

28. The apparatus according to claim 16, wherein the second end of the supply line is located at an underwater hydrocarbon extraction facility.

29. The apparatus according to claim 16, wherein the chemical mixture is substantially homogeneous.

30. The apparatus according to claim 16, further comprising a mixing means for mixing the at least two non-identical chemicals to form the chemical mixture.
